(19) United States
(12) Patent Application Publication
(10) Pub. No.: US 2023/0286244 A1
(43) Pub. Date: Sep. 14, 2023

(54) APPARATUS FOR MANUFACTURING A CUSHIONING PRODUCT

(71) Applicant: Storopack Hans Reichenecker GMBH, Metzingen (DE)

(72) Inventors: Paul Deis, Preuschdorf (FR); Jean-Marc Slovencik, Rosenfeld (DE)

(21) Appl. No.: 18/041,599

(22) PCT Filed: Aug. 12, 2021
(86) PCT No.: PCT/EP2021/072542

§ 371 Date: Feb. 14, 2023

(30) Foreign Application Priority Data
Aug. 19, 2020 (DE) 10 2020 121 788.9

(51) Int. Cl. B31D 5/00

(52) U.S. Cl. CPC B31D 5/0052; B31D 2205/0094

(57) ABSTRACT

Described is an apparatus for manufacturing a cushioning product from an elongate paper strip, said apparatus comprising at least one cover in the area of an exit region of the finished cushioning product. Said first cover is releasably connected to the apparatus by means of a linear guide.

The invention relates to an apparatus for manufacturing a cushioning product, which is manufactured from a flat, elongate two- or multi-layer paper strip.

A generic apparatus for manufacturing a cushioning product is known from DE 10 2012 222 805 A1. This length of the cushioning product can be adjusted by a subsequent separation process (cutting or separation along a perforation).

The finished cushioning products are conveyed through a dispensing opening of the apparatus and are available to the user.

For reasons of work safety among other things, the apparatus for manufacturing a cushioning product together with the optional separating unit is enclosed by a housing. The intake and dispensing openings must be designed in such a way that the relevant accident prevention regulations are observed and injuries, even if resulting from improper use, are avoided.

In daily use, it is not necessary for the user to have access to the interior of the apparatus, for example to maintain the apparatus, to clear a paper jam, or to replace the blades of an optional cutting mechanism. Parts of the housing must be removed for this purpose.

The object of the present invention is, inter alia, to provide a particularly user-friendly and safe apparatus for manufacturing a cushioning product.

This object is achieved by means of an apparatus having the features of claim 1.

In particular, this object is achieved by an apparatus for manufacturing a cushioning product comprising an inlet region for a flat, elongate, two- or multi-layer paper strip and an exit region for a cushioning product manufactured from the paper strip, comprising a feed mechanism and a crumple mechanism for crumpling the paper strip, the exit region comprising a removable first cover with a dispensing opening, and the inlet region also optionally comprising a removable second cover with an inlet opening, characterized in that the first cover and/or the optional second cover can be connected to the apparatus with a linear guide.

According to the invention, it is therefore provided to connect the first cover of the exit region and the optional second cover of the inlet region to the apparatus, or to release it from the apparatus if necessary, via a linear guide.

This type of connection is particularly advantageous, because the paper strip or the finished cushioning product has an elongate structure and the cushioning product is transported substantially in a straight line through the apparatus. Because the linear guide according to the invention corresponds to the elongate structure of the cushioning product and its transport direction through the apparatus, it is possible under virtually all conceivable conditions to remove the first or the second cover. This also applies, and in particular if, for example due to a material defect or a malfunction of the apparatus, the cushioning product has become jammed or wedged inside the apparatus and there is an “improper” state of the cushioning product or the apparatus.

The linear guide according to the invention is very easy to manufacture. Thanks to the linear guide, it is also possible to adjust the cover(s) in such a way that they/it fit(s) with the actual housing of the apparatus in the best possible manner and within close tolerances.

The linear guide according to the invention is also very robust so that it has a long service life and has to be repaired or readjusted only rarely, even in rough everyday operation.

In an advantageous embodiment of the invention, the linear guide comprises two guide strips each having at least one guide edge and two slide pieces formed complementary to the guide strips or the guide edges thereof.

In this exemplary embodiment, the linear guide according to the invention is based on the “tongue and groove” principle. The guide strips are preferably made of metal (sheet steel or sheet aluminum) so that they are very stable. They can be manufactured cost-effectively and in high quality, for example by punching and/or bending or laser cutting and/or bending.

The slide pieces interacting with the guide strips can consist of a plastic. Polyamide or another plastic with similarly good sliding properties is well suited for this purpose. The slide pieces can be manufactured by plastic injection molding or from an extruded profile.

The result is a very durable and resilient linear guide. Due to the material combination of metal and plastic, a sliding behavior that is haptically or tactilely very pleasant for the user is established; which imparts a high-quality impression to the user.

In an advantageous embodiment of the invention, the guide edges of the guide strips are arranged parallel to one another and opposite one another. The slide pieces have a groove which interacts with the guide edge of a guide strip in order to realize the aforementioned tongue and groove principle.

The mechanical load-bearing capacity and the accuracy of the linear guide according to the invention can be adapted within wide limits to the requirements of an application.

It is also easily possible to make design provisions for an end stop for the cover. For example, a projection or shoulder is provided in the region of the guide edges of the guide strips.

In an advantageous embodiment of the invention, the guide strips are connected, in particular screwed, to the apparatus, i.e., a rack which carries the feed mechanism and/or the crumple mechanism. The slide pieces are preferably assigned to the cover. However, it is also possible to fasten the slide pieces to the rack of the apparatus and to connect the guide strips directly or indirectly to the cover.

In a further addition to the linear guide according to the invention, the first cover comprises a first and a second safety plate, wherein the slide pieces are arranged between the safety plates. The slide pieces can be screwed to safety plates or clamped between them in some other way.

The safety plates form a channel which in normal operation serves to transport the finished cushioning product to the exit opening after leaving the crumple apparatus. The cross section of the channel is advantageously formed geometrically similar to the cross section of the finished cushioning product. As a result, the finished cushioning product can be conveyed in the channel from the crumple apparatus to the exit opening. The safety plates also prevent a “lateral” escape of the cushioning product. Reliability and freedom from interference of the apparatus according to the invention are further improved by this channel.

Due to the fact that the slide pieces are arranged between the safety plates and are generally connected to them by a screw connection, the linear guide can also be adjusted in a simple manner by adjusting the distance of the slide pieces from one another and subsequently screwing the safety plates to the slide pieces or by gripping or clamping the slide pieces between the safety plates. This type of adjustment of the slide pieces also allows the slide pieces to be readjusted when wear occurs in the guide groove, so that a linear guide with little play is ensured over the entire service life of the apparatus according to the invention.

The linear guide according to the invention can comprise abutment means and/or locking means so that the cover is locked in the desired position. For example, these abutment means can be realized by shoulders or projections in the guide strips.

The locking means can be designed as a snap connection or latching connection. It is also possible to use screws or pins to lock the cover relative to the guide rails or the apparatus in the normal or operating position. This ensures that the cover always remains in the desired place during operation of the apparatus, even if external forces are acting on the cover. Only when the cover is to be actively removed from the apparatus are the locking means released and the cover can be removed from the apparatus via the linear guide according to the invention.

In order to support a low-disruption the transport of the preliminary product or the finished cushioning product by the apparatus, guide plates are arranged inside the apparatus, which guide plates together with the safety plates form a channel which does not have a disruptive contour. Preferably, the channel expands slightly in the transport direction at the end of the guide plates in the transition to the safety plates.

In order to minimize the risk of accident and risk of injury, an electrical safety switch is provided in a further advantageous embodiment of the invention. This electrical switch enables the current for operating the apparatus according to the invention. It is closed when the first cover or the second cover is in the normal or operating position. As soon as one of the covers is removed, the safety switch opens so that the power supply to the apparatus is interrupted and neither the transport apparatus nor the crumple apparatus can start. In this way, injury of an operator performing maintenance work on the apparatus is prevented.

The advantages of a linear guide according to the invention can also be realized in an inlet region when the inlet region comprises a detachable second cover with an inlet opening and the second cover is realized with a linear guide according to any of the preceding claims.

As a rule, the linear guide in the region of the first cover and of the exit region is of greater importance because experience shows that disturbances occur more frequently during the transport of the finished cushioning product out of the apparatus than when the flat paper strip is inserted into the inlet region of the apparatus according to the invention. Nevertheless, the second cover can be connectable to the apparatus also in the inlet region by means of a linear guide according to the invention.

Further advantages and advantageous embodiments of the invention can be found in the following description, on the basis of which an exemplary embodiment of the invention is described and explained in more detail.

### DRAWING

Shown are:

FIG. 1 an isometric view of an apparatus according to the invention with a housing that is open in regions;

FIG. 2 a longitudinal section of the apparatus according to FIG. 1;

FIG. 3 an enlarged detail from FIG. 4;

FIG. 4 the guide according to the invention of the dispensing opening;

FIG. 5 upper and lower safety plates;

FIG. 6 a channel formed from the safety plates;

FIG. 7 the first cover;

FIG. 8 a detail from FIG. 1;

FIG. 9 a perspective view of an apparatus according to the invention with the first cover in its normal or operating position.

FIGS. 10 and 11 details of the guide of the cushioning product by the apparatus according to the invention and a locking mechanism.

### DESCRIPTION OF THE EXEMPLARY EMBODIMENT

The invention is explained below with reference to the figures. The focus of the description is on the linear guide according to the invention of the cover of the exit region and less on the mode of operation of the apparatus for manufacturing a cushioning product. The mode of operation is known to the person skilled in the art. It is explained in detail, for example, in the patent specification DE 10 2012 222 805 B3 of the applicant.

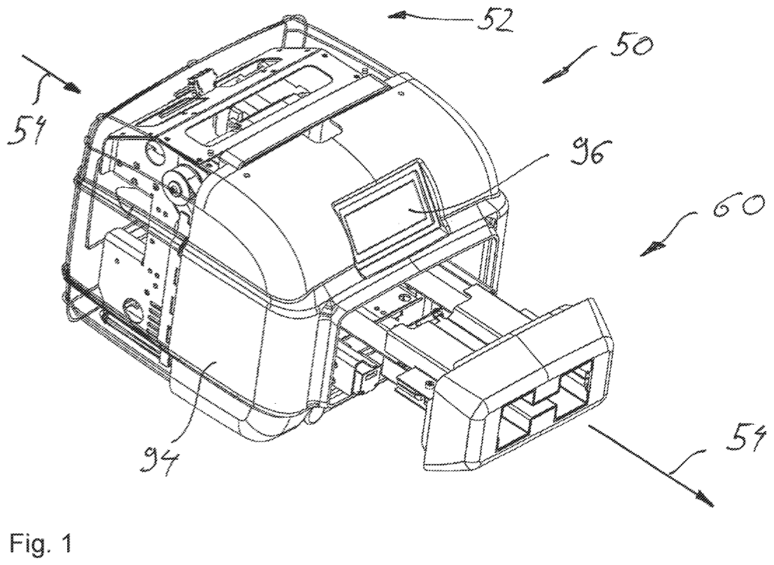

FIG. 1 is an isometric view of an apparatus 50 according to the invention. The left part of the apparatus 50 in FIG. 1 is the so-called inlet region. It is partially cut free. The right part in FIG. 1 is the so-called exit region 60.

In the exit region 60, there is a first cover 90 with an exit opening 92, which in this exemplary embodiment is formed in cross section similar to a “dumbbell.” The finished cushioning product emerges from the exit opening 92. For the sake of completeness, reference is also made to a housing 94 of the apparatus 50 and a display 96 of the apparatus 50.

In FIG. 1, the cover 90 together with the exit opening 92 is not shown in the normal or operating position, which it assumes during operation of the apparatus. It is shown in position after it has been pulled out of the apparatus along the linear guide according to the invention.

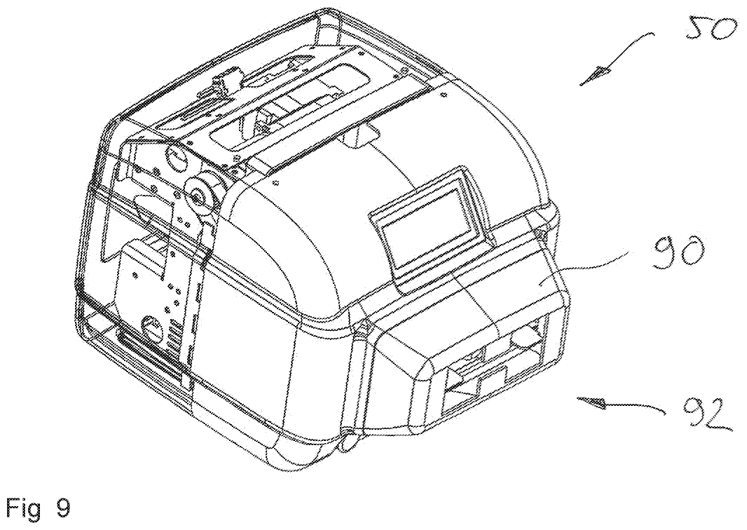

In the normal or operating position, the cover 90 bears directly against the housing 94 so that a closed outer contour of the apparatus 50 results (see FIG. 9).

The paper strip, which is formed in the apparatus 50 into a cushioning product, passes through the apparatus 50 in a transport direction 54 indicated by an arrow in FIG. 1. This means that a flat paper strip (not shown) enters the apparatus 50 in the inlet region 52 through an inlet opening (not visible in FIG. 1) and leaves the apparatus 50 again as a crumpled cushioning product in the region of the exit opening 92.

The linear guide according to the invention is arranged parallel to the transport direction 54 so that the first cover 90 can be removed from the apparatus at the exit region 60 in the transport direction. By removing the first cover 90, the paper or the cushioning product located in the apparatus 50 is not moved or only slightly moved. In particular, the paper strip and the cushioning product are not influenced from the transport direction. As a result, it is possible under all circumstances to remove the first cover 90 from the housing 94 of the apparatus 50; even if a paper jam should occur inside the apparatus.

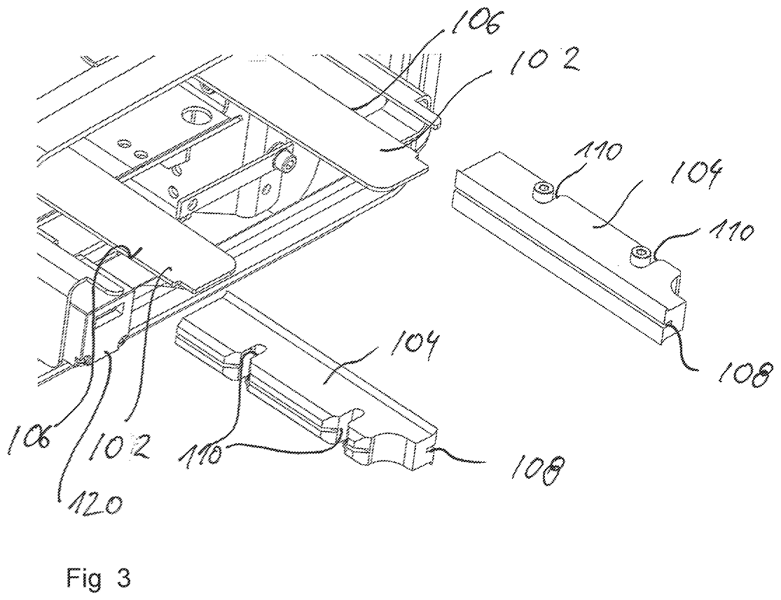

Details of the linear guide according to the invention are explained below with reference to FIGS. 3 to 7.

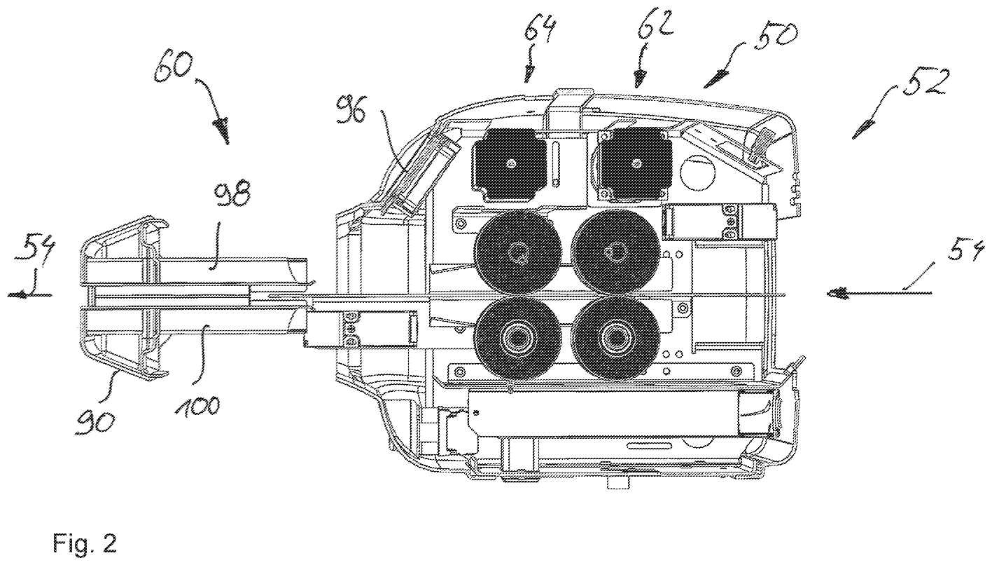

FIG. 2 shows a longitudinal section through the apparatus according to the invention according to FIG. 1. The transport direction 54 is also shown. A feed mechanism 62 known per se is indicated in this longitudinal section. It comprises a pair of rollers between which the paper strip is clamped and conveyed by rotating the rollers in the transport direction 54.

A crumple mechanism 64 is arranged behind the feed mechanism 62 in the transport direction 54. This crumple mechanism 64 also consists of two rollers, or a roller pair, between which the paper strip is clamped and transported. As is known from DE 10 2012 222 805 B3, the crumpling of the paper strip is essentially accomplished by the transport speed of the crumple mechanism 64 being less than that of the feed mechanism 62. As a result of the speed difference between the crumple mechanism 64 and the feed mechanism 62, the paper strip is “dammed up” with the consequence that the paper strip is crumpled. This results in the cushioning product which occupies a large spatial volume and is elastic. Generally, it has a dumbbell-shaped cross section.

The impact cores required for this purpose and other details are not shown in FIG. 2 because they are not the subject matter of the claimed invention.

In FIG. 2, the first cover 90 and parts of the linear guide according to the invention as well as two safety plates 98 and 100 can be seen. The individual parts of the linear guide and the safety plates are explained in more detail below.

FIG. 3 shows the essential components of an exemplary embodiment of the linear guide according to the invention. It comprises two guide strips 102 and two slide pieces 104 interacting therewith. The guide strips 102 each have a guide edge 106 which, together with the guide grooves 108 in the slide pieces, forms the actual linear guide.

In this exemplary embodiment, the guide edges 106 of the guide strips 102 face away from one another, i.e., they are located on the outside of the guide strips 102. Accordingly, the guide grooves 108 of the slide pieces 104 face one another.

The slide pieces 104 have elongated holes 110 that are open to the side. The elongated holes 110 accommodate screws. The associated screw heads are shown (without reference signs) in the right sliding piece 104 in FIG. 3. The guide strips 102 are fixedly connected to the actual apparatus 50. This is generally accomplished by screw connections with a supporting structure of the apparatus 50, such as a rack or a frame.

FIG. 3 shows a safety switch 120. It interrupts the power supply to the drives of the feed mechanism and the crumple mechanism as soon as the first cover leaves its operating or normal position (see FIG. 9). This happens by it being removed from the apparatus 50 in the transport direction 54. It is guided here by the linear guide according to the invention until the slide pieces 104 have left the guide strips 102.

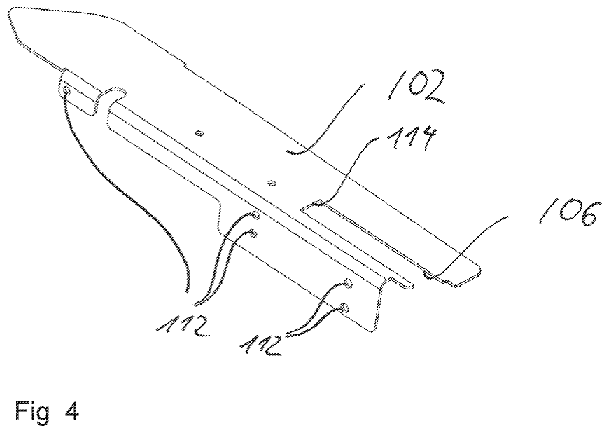

FIG. 4 shows the left guide strip 102 in FIG. 3 in detail. FIG. 4 shows that in this exemplary embodiment, the guide strip 102 is manufactured in cross section as an L-shaped bent sheet metal part. In the leg of the guide strip 102 extending vertically in FIG. 4, fastening bores 112 are formed by means of which the guide strip 102 can be screwed to the actual apparatus 50. The bore 112 may also be designed as elongated holes.

The guide edge 106 is relatively short. Its end (see reference sign 114) can be designed as a depth stop for the linear guide according to the invention. The guide strip 102 arranged on the right side in FIG. 3 is structurally identical only with respect to mirror symmetry. It is also screwed to the apparatus 50.

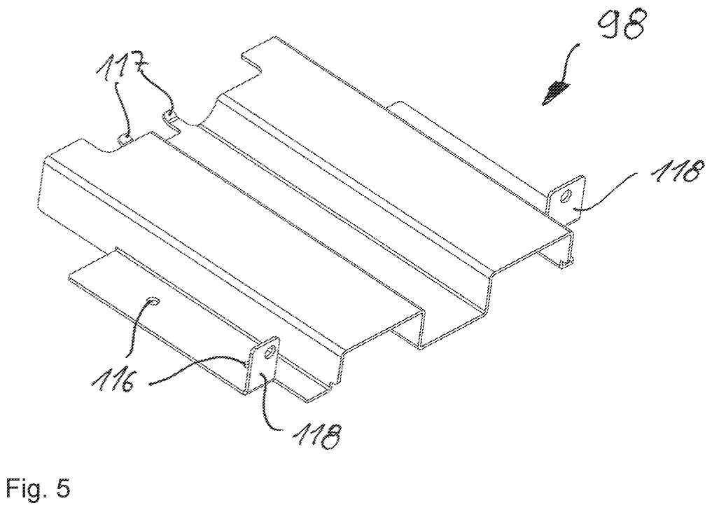

FIG. 5 shows a first safety plate 98. A second safety plate 100 is of a design similar to that of the first safety plate 98. The first safety plate 98 has two rectangular elevations in cross section. The first safety plate 98 can also be manufactured in a simple manner by laser cutting or punching and subsequent bending. There are apertures 116 in the first safety plate 98, but also in the second safety plate 100 (not shown). Screws are inserted through these apertures 116 and the elongated holes 110 of the slide pieces 104. By tightening these screws, the slide pieces 104 are gripped or clamped between the first safety plate 98 and the second safety plate 100 and a channel with a “dumbbell-shaped” cross section is formed. The cushioning product moves in the channel from the crumple apparatus 42 to the exit opening 92.

On the right side of the first safety plate 98 in FIG. 5, there are likewise two fastening bores 116 which, however, are concealed by the rectangular prismatic elevation of the first safety plate 98.

The safety plates 98 have two slightly bent resilient tongues 117 on their front end in the transport direction 54. The bent ends of the tongues 117 support the retraction of the safety plates 89, 100 into the apparatus 50.

The safety plates 98 have two tabs 118 on their rear end in the transport direction 54. The first cover 90 is screwed to the first safety plate 98 at the tabs 118.

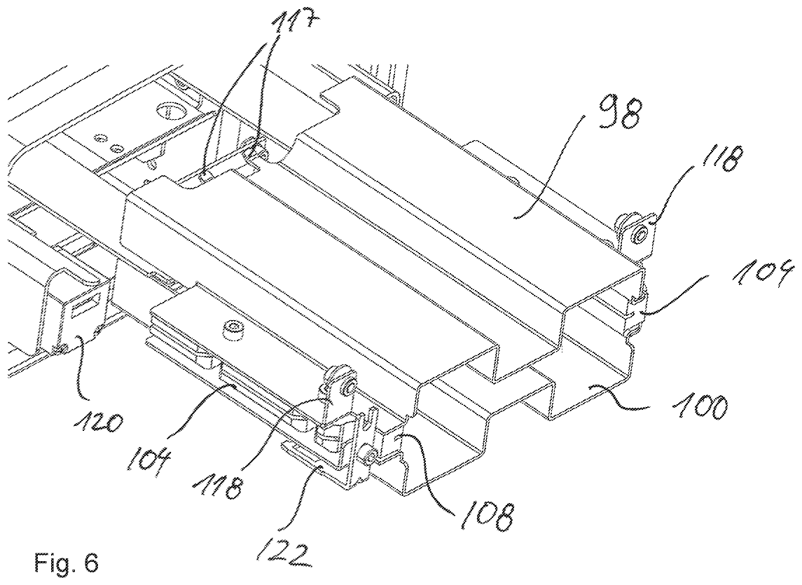

FIG. 6 shows the situation that the first safety plate 98 and the second safety plate 100 together with the slide pieces 104 form an assembly which forms the already mentioned channel. FIG. 6 clearly shows the opposite arrangement of the guide grooves 108.

In this illustration, it can also be clearly seen that the screws (without reference signs) which connect the first safety plate 98 and the second safety plate 100 to one another extend through the elongated holes 110 of the slide pieces 104. By tightening the mounting screws, the slide pieces 104 are gripped or clamped between the first and second safety plates 98, 100.

The elongated holes 110 make it possible to precisely adjust the distance and the orientation of the guide grooves 108. The linear guide is adjusted by moving the slide pieces 104 relative to the safety plates 98, 100. By tightening the mounting screws, the slide pieces 104 are fixed in the desired position between the safety plates 98, 100.

As already mentioned, the channel formed between the first safety plate 98 and the second safety plate 100 has approximately the shape of a dumbbell in cross section. This channel conveys the finished cushioning product from the crumple apparatus 64 through the exit opening 92. The channel ensures that the finished cushioning product cannot escape laterally and retains its crumpled shape. At the same time, the channel is designed such that the user or operator of the apparatus 50 cannot reach into the channel with their hand or a finger so far that they reach the crumple apparatus 64.

FIG. 6 shows the tabs 118 on the first safety plate 98 with screwed-in mounting screws (without reference signs). The mounting screws are used to fasten the first cover 90 to the first safety plate 98. This results in a firm connection between the slide pieces 104 and the first cover 90.

An actuating element 122, which interacts with the safety switch 120, is fastened to the second safety plate 100. It comprises an actuating section running parallel to the transport direction 54 and comprising an aperture 124. The actuating section extends into an opening of the safety switch 120 when the first cover 90 is in its operating or normal position. The safety switch 120 then closes and enables the power supply of the drives for the feed mechanism and the crumple mechanism 62, 64. As soon as the first cover 90 not in the operating or normal position, the safety switch 120 interrupts the power supply.

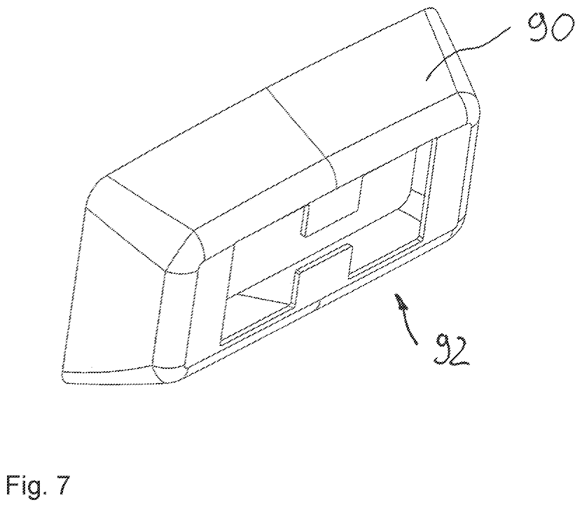

FIG. 7 shows the first cover 90 again individually. It has an exit opening 92, the cross section of which corresponds to the cross section of the channel formed by the safety plates 98 and 100.

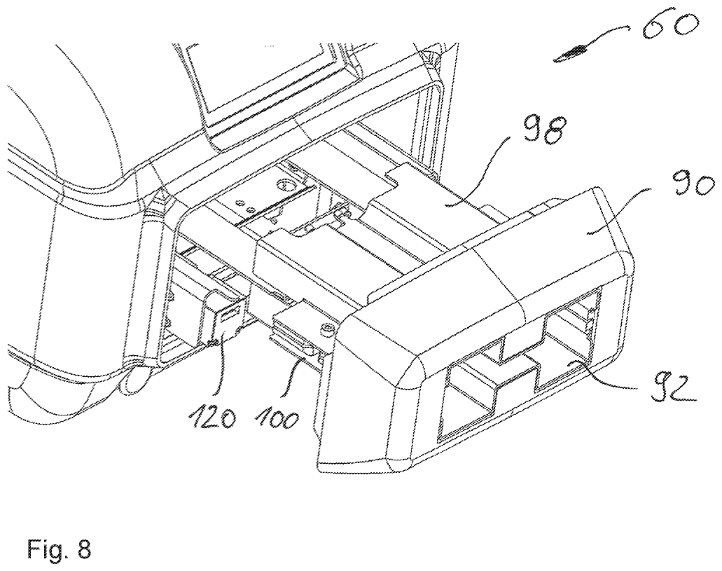

In FIG. 8, the complete linear guide with the first cover 90 placed thereon is shown again enlarged correspondingly to FIG. 2. The design and the mode of operation of the linear guide according to the invention can be clearly understood from what is collectively shown by FIGS. 3 to 7 and FIGS. 2 and 8.

FIG. 9 shows the apparatus again in an isometric view with a closed first cover.

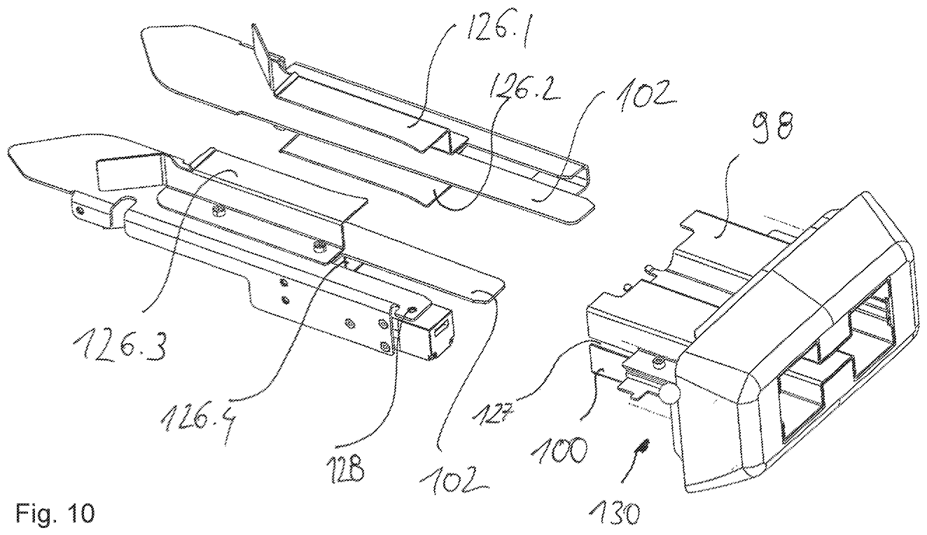

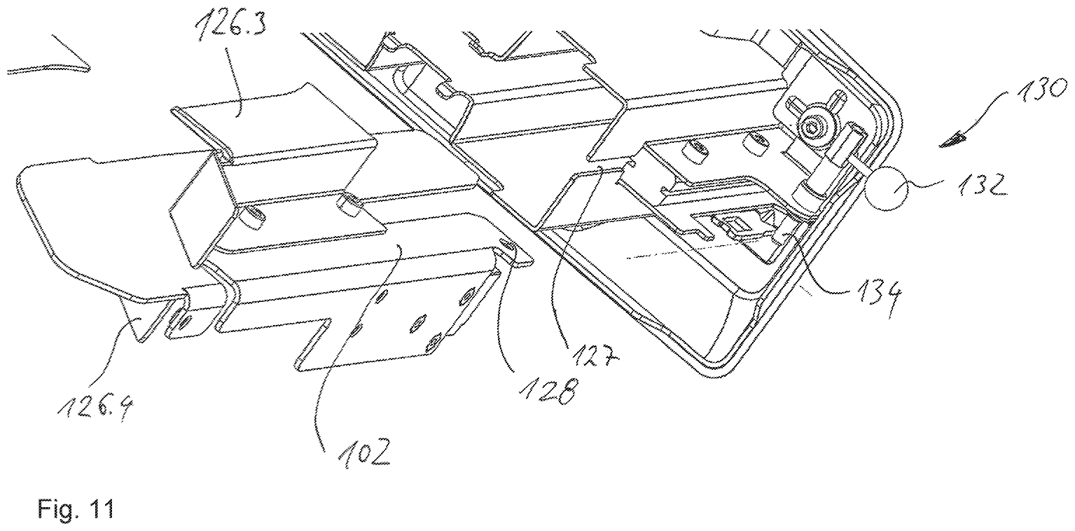

Further details of the invention are illustrated and explained below with reference to FIGS. 10 and 11. It can be clearly seen from FIG. 10 that in this exemplary embodiment, a guide plate 126 is respectively provided above and below the guide strips 102. In total, there are four guide plates 126.1 to 126.4. The guide plates 126 guide the cushioning product from the inlet region 52 toward the exit region 60. They can be screwed to the guide strips 102.

The shape and dimensions of the guide plates 126 are selected such that they are enclosed by the safety plates 98 and 100 when the first cover 90 is in its operating or normal position (see FIG. 9).

There is therefore a gap 127 between the safety plates 98 and 100, which gap can be clearly seen in FIG. 10. This arrangement is particularly advantageous because the channel, formed by the guide plates 126, for the cushioning product has a slightly smaller cross section than the channel formed by the safety plates 98 and 100. In other words: In the transport direction, the channel through which the cushioning product is transported expands somewhat at the end of the guide plates 126 in the transition to the safety plates 98 and 100. As a result, the cushioning product is not jammed during transport through the apparatus 50.

The exemplary embodiment shown in FIGS. 10 and 11 comprises a lock which will be explained below.

A tab with a recess 128 is shown in the left guide strip 102 in FIG. 10. It cooperates with a locking mechanism 130, which is connected to the first cover 90 or to one of the safety plates 98, 100. In FIG. 10, only one button 132 from the locking mechanism 130 can be seen, which button can be used to lock or unlock the locking mechanism 130.

As can be seen from FIG. 11, the locking mechanism 130 comprises a pin 134, which pin can move into the recess 128 when the first cover 90 is in its operating or normal position (see FIG. 9).

The pin 134 is preferably spring-loaded so that the pin 134 always enters the recess 128 on its own. The lock is then active, and the first cover 90 remains in its operating or normal position.

When the first cover 90 is to be pulled out of the housing 94, the pin 134 is pulled out of the recess 128 against the force of a spring (not shown). This happens by a person pulling the button 132 upward (in FIG. 11). The lock is then released, and the first cover 90 can be pulled out of the housing 94.

The spring (not shown) is located in a housing 136 of the locking mechanism, which also takes over the guiding of the pin 134.

The first cover 90 is arranged in the exit region 60 of the apparatus 50 according to the invention. In a corresponding manner, it is however also possible to equip a second cover in the region of the inlet region 52 with a linear guide according to the invention. The structural details correspond to the linear guide of the first cover 90. Therefore, a further explanation and description of this second linear guide in the inlet region 52 is dispensed with.

1. Apparatus for manufacturing a cushioning product, comprising an inlet region for a flat, elongate, two- or multi-layer paper strip and an exit region for a cushioning product manufactured from the paper strip, comprising a feed mechanism and a crumple mechanism for crumpling the paper strip, the exit region comprising a removable first cover with a dispensing opening, wherein the first cover is connectable to the apparatus by means of a linear guide, wherein the linear guide is arranged parallel to a transport direction.

2. Apparatus according to claim 1, wherein the linear guide comprises two guide strips and two complementarily shaped slide pieces.

3. Apparatus according to claim 2, wherein the guide strips each have at least one guide edge, wherein the guide edges of the guide strips are arranged parallel to one another and opposite one another, and wherein the slide pieces each have a guide groove which interacts with the guide edge of a guide strip.

4. Apparatus according to claim 2, wherein the guide strips are connected to the apparatus and the slide pieces are connected to the first cover.

5. Apparatus according to claim 1, wherein the first cover comprises a first and a second safety plate, and wherein the slide pieces are arranged between the safety plates.

6. Apparatus according to claim 5, wherein the first and second safety plates and/or the dispensing opening of the first cover form a channel, and wherein a cross section of the channel and a cross section of the finished cushioning product are geometrically similar.

7. Apparatus according to claim 1, wherein it comprises locking means to releasably connect the first cover to the apparatus.

8. Apparatus according to claim 7, wherein the locking means comprise a recess in one of the guide strips and a locking mechanism with a pin, and wherein the pin can retract into the recess in the operating or normal position of the first cover.

9. Apparatus according to claim 5, wherein it has a plurality of guide plates, which together with the safety plates form a transport path or transport channel for the cushioning product.

10. Apparatus according to claim 1, wherein the inlet region comprises a removable second cover with an inlet opening, and wherein the second cover can be connected to the apparatus by means of the linear guide, wherein the linear guide comprises two guide strips and two complementarily shaped slide pieces.
